(19) United States
(12) Patent Application Publication
(10) Pub. No.: US 2026/0292818 A1
(43) Pub. Date: Sep. 24, 2026

(54) MULTIPLEXING TRACKING REFERENCE SIGNALS WITH SYSTEM INFORMATION MESSAGES

(71) Applicant: QUALCOMM Incorporated, San Diego, CA (US)

(72) Inventors: Chih-Hao LIU, San Diego, CA (US); Jing SUN, San Diego, CA (US); Jing LEI, San Diego, CA (US)

(21) Appl. No.: 19/086,094

(22) Filed: Mar. 20, 2025

(51) Int. Cl. H04W 72/1273; H04L 5/00; H04W 72/0446

(52) U.S. Cl. CPC H04W 72/1273; H04L 5/0044; H04W 72/0446

(57) ABSTRACT

This disclosure provides methods, components, devices and systems for multiplexing tracking reference signals with system information messages, such as remaining minimum system information (RMSI) messages. For example, a user equipment (UE) may receive one or more tracking reference signals (TRSs) via a physical downlink shared channel (PDSCH), in which case the one or more TRSs may be multiplexed with the RMSI, or via a physical downlink control channel (PDCCH), in which case the one or more TRSs may multiplexed with a control message scheduling the RMSI. In some cases, when the UE is in an idle mode, the one or more TRSs may occupy a same bandwidth as the RMSI. Alternatively, when the UE is in a connected mode, the TRSs may occupy a larger bandwidth than the RMSI.

### TECHNICAL FIELD

This disclosure relates generally to wireless communication, and more specifically to systems, devices, methods, and techniques associated with multiplexing tracking reference signals (TRSs) with system information messages.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving one or more first control messages indicative of first configuration information associated with one or more tracking reference signals (TRSs) and second configuration information associated with a system information message, where the first configuration information is based on the second configuration information and receiving, in accordance with the first configuration information, the one or more TRSs, where the one or more TRSs are multiplexed with the system information message, a second control message that schedules the system information message, or both.

A UE for wireless communications is described. The UE may include a processing system that includes processor circuitry and memory circuitry that stores code. The processing system may be configured to cause the UE to receive one or more first control messages indicative of first configuration information associated with one or more TRSs and second configuration information associated with a system information message, where the first configuration information is based on the second configuration information and receive, in accordance with the first configuration information, the one or more TRSs, where the one or more TRSs are multiplexed with the system information message, a second control message that schedules the system information message, or both.

Another UE for wireless communications is described. The UE may include means for receiving one or more first control messages indicative of first configuration information associated with one or more TRSs and second configuration information associated with a system information message, where the first configuration information is based on the second configuration information and means for receiving, in accordance with the first configuration information, the one or more TRSs, where the one or more TRSs are multiplexed with the system information message, a second control message that schedules the system information message, or both.

A non-transitory computer-readable medium storing code for wireless communications is described. The code may include instructions executable by one or more processors (e.g., directly, indirectly, after pre-processing, without pre-processing) to receive one or more first control messages indicative of first configuration information associated with one or more TRSs and second configuration information associated with a system information message, where the first configuration information is based on the second configuration information and receive, in accordance with the first configuration information, the one or more TRSs, where the one or more TRSs are multiplexed with the system information message, a second control message that schedules the system information message, or both.

In some examples of the method, UEs, and non-transitory computer-readable medium described herein, receipt of the one or more TRSs may be via a physical downlink shared channel (PDSCH) associated with the system information message and the one or more TRSs may be multiplexed with the system information message on the PDSCH.

In some examples of the method, UEs, and non-transitory computer-readable medium described herein, a first tone offset of the one or more TRSs may be the same as a second tone offset of one or more demodulation reference signals (DMRSs) associated with the PDSCH.

In some examples of the method, UEs, and non-transitory computer-readable medium described herein, the one or more TRSs may be received on a first set of symbols of the PDSCH and one or more DMRSs may be received on a second set of symbols of the PDSCH, different from the first set of symbols.

In some examples of the method, UEs, and non-transitory computer-readable medium described herein, receipt of the one or more TRSs may be via a physical downlink control channel (PDCCH) associated with the second control message that schedules the system information message and the one or more TRSs may be multiplexed with the second control message on the PDCCH.

In some examples of the method, UEs, and non-transitory computer-readable medium described herein, a first tone offset of the one or more TRSs may be the same as a second tone offset of one or more DMRSs associated with the PDCCH.

In some examples of the method, UEs, and non-transitory computer-readable medium described herein, the one or more TRSs may be received via a first set of time resources of the PDCCH and one or more DMRSs may be received via a second set of time resources of the PDCCH, different from the first set of time resources.

### BRIEF DESCRIPTION OF THE DRAWINGS

FIG. 1 shows an example of a wireless communication system.

FIG. 2 shows an example of a signaling diagram that supports multiplexing tracking reference signals (TRSs) with system information messages.

FIG. 3 shows an example of a process flow that supports multiplexing TRSs with system information messages.

FIG. 4 shows a block diagram of a processing system that supports multiplexing TRSs with system information messages.

FIG. 5 shows a diagram of a system including a device that supports multiplexing TRSs with system information messages.

FIG. 6 shows a flowchart illustrating methods that support multiplexing TRSs with system information messages.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IOT), narrowband IoT (NB-IOT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may receive one or more tracking reference signals (TRSs) for performing channel estimation measurements. For example, one TRS may be configured for each synchronization signal block (SSB) beam, which may enable the UE to estimate channel characteristics (e.g., perform channel estimation measurements) per SSB. In some examples, it may be beneficial for the UE to obtain channel estimation measurements prior to receipt of remaining minimum system information (RMSI) via one or more system information messages (e.g., system information block (SIB)−1), such as to improve a decoding of the RMSI. However, a configuration of resources for the TRSs may occur after the UE has already received the RMSI, and thus the UE may be unable to leverage received TRSs for decoding of the RMSI.

Aspects of the subject matter described in this disclosure relate to multiplexing TRSs with RMSI, with a control message that schedule the RMSI, or both. For example, the UE may receive one or more TRSs via a physical downlink control channel (PDCCH), in which case the one or more TRSs may be multiplexed, on the PDCCH, with the control message (e.g., downlink control information (DCI)) that schedules the RMSI. Additionally, or alternatively, the UE may receive one or more TRSs via a PDSCH, in which case the one or more TRSs may be multiplexed, on the PDSCH, with the RMSI. In some cases, such as when the UE is in an idle (e.g., inactive) mode, the one or more TRSs may occupy a same bandwidth as the RMSI, which may be defined by a default bandwidth part (BWP) (e.g., a control resource set (CORESET) 0). Alternatively, when the UE is in a connected (e.g., active) mode, the one or more TRSs may occupy a larger bandwidth than the RMSI. For example, the one or more TRSs may be associated with an active BWP (e.g., may span an entire active BWP), while the RMSI may be associated with the default BWP, where the active BWP is larger than the default BWP. In some implementations, the one or more TRSs multiplexed in the PDCCH, the PDSCH, or both, may be received in addition to one or more demodulation reference signals (DMRSs), or the one or more TRSs may replace the one or more DMRSs (e.g., be received instead of the one or more DMRSs).

Particular aspects of the subject matter described in this disclosure can be implemented to realize one or more of the following potential advantages. In some examples, by multiplexing the one or more TRSs and RMSI in the PDCCH, the PDSCH, or both, the described techniques can be used to enable the UE to leverage the one or more TRSs during channel estimation for the RMSI, thus improving the decoding of the RMSI. For example, the UE may receive the one or more TRSs over a wider bandwidth than a bandwidth of the RMSI, which may enable the UE to increase channel estimation accuracy and efficiency, resulting in reduced latency, decreased power consumption, and increased spectral efficiency. Moreover, by multiplexing the one or more TRSs and RMSI in the PDCCH, the PDSCH, or both, one or more DMRSs associated with the PDCCH, the PDSCH, or both, may be combined with the one or more TRSs, or even dropped, resulting in additional resources being available for the RMSI, thus improving throughput.

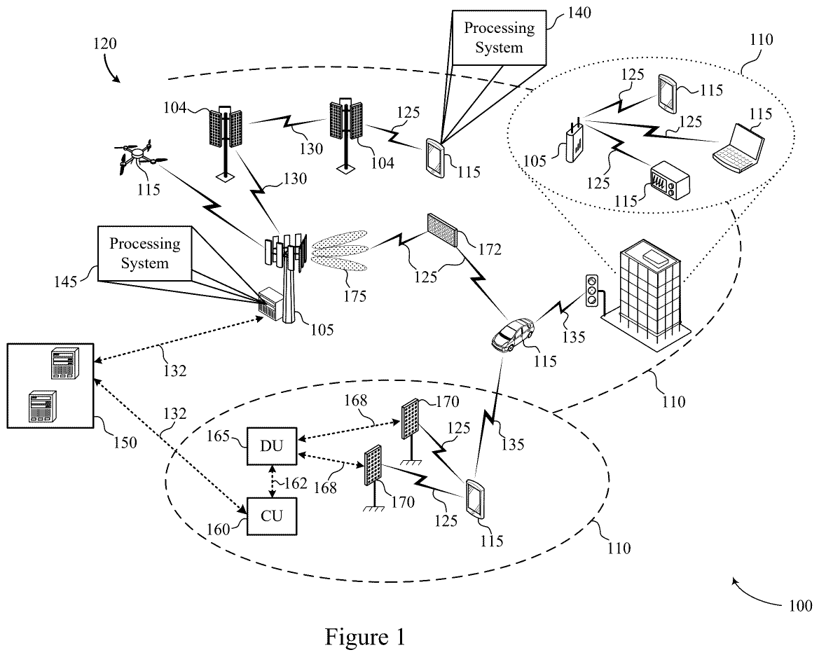

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a PDSCH for communicating user data in a downlink direction and a physical uplink shared channel (PUSCH) for communicating user data in an uplink direction. Physical control channels (such as for managing communication via physical channels) may include a PDCCH for communicating DCI and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase TRSs (PTRSs) for evaluating oscillator characteristics, among others. Network entities 105 and UEs 115 may receive and measure transmitted reference signals to support one or more of these and other functions.

In some examples of the wireless communications system 100 (e.g., in NR), an always on configuration for cell-specific reference signals (CRSs) may be nonexistent. In some such examples, a network entity 105 may configure periodic TRSs for communication to the UE 115, which may be used (e.g., at the UE) for time and frequency tracking, as well as Doppler estimation, delay spread estimation, or both. The network entity 105 may configure the periodic TRSs via one or more CSI-RS resource sets. For example, the network entity 105 may configure periodic TRSs for each UE (e.g., in the wireless communications system 100) via RRC signaling. In some examples, the network entity 105 may switch the transmission of the periodic TRSs on and off per UE via an RRC configuration or reconfiguration.

In some other examples, the network entity 105 may configure aperiodic TRSs for communication to the UE 115. The aperiodic TRSs may supplement periodic TRSs for a loop update, such that the UE 115 may use the aperiodic TRSs to perform the loop update during one or more events (e.g., aperiodic event, periodic event) which may be misaligned with instances of the periodic TRSs. Examples of such events may include secondary cell (SCell) activation, BWP switching, a multi-beam change, DRX operations, or a combination thereof.

In some examples, the network entity 105 may communicate TRSs to a UE 115 in an idle (e.g., inactive) mode, and the TRSs may enable the UE 115 to update one or more loops before being paged. In such examples, the network entity 105 may transmit (e.g., broadcast), via one or more system information blocks (SIBs), an indication of cell specific TRS resources configured for the UE in the idle mode. The network entity 105 may communicate a paging early indication to indicate which of the configured TRS resources are available. In some examples, a SIB-17 (e.g., SIB-R17) of the one or more SIBs may indicate a periodicity (e.g., periodicityAndOffset-r17), an offset (e.g., periodicityAndOffset-r17), a starting common RB (CRB) (e.g., startingRB-r17), a quantity of RBs (e.g., nrofRBs-r17), one or more RE offsets, an associated SSB index (e.g., ssb-Index-r17), or any combination thereof, of the cell specific TRS resources configured for the UE 115.

In some examples, the network entity 105 may configure the UE 115 with one TRS for each SSB beam, which may enable the UE 115 to estimate a power delay profile (PDP), timing, Doppler, and signal-to-noise ratio (SNR), or any combination thereof, per SSB. In such cases, a periodicity of the TRS may be the same as (e.g., or a multiple of) a periodicity of the corresponding SSB. Each SSB beam may correspond to respective RMSI, where the RMSI may be included in one or more system information messages, such as a SIB-1 message.

In some cases, it may be beneficial for the UE 115 to receive one or more TRSs for performing channel estimation prior to receipt of one or more system information messages, such as RMSI (e.g., SIB-1), from the network entity 105, such as to improve a decoding of the RMSI (e.g., to increase accuracy or efficiency of the decoding). However, the configuration of the cell specific TRS resources received via the SIB-17 may come after the UE 115 has already decoded the RMSI (e.g., SIB-1) messages, and thus the UE 115 may be unable to leverage the one or more TRSs for the decoding of the RMSI.

Devices of the wireless communication system 100 may be configured to support one or more aspects of the described techniques for multiplexing TRSs with RMSI. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support an increased efficiency of communication resources by multiplexing TRSs with other signaling. By multiplexing the TRS with RMSI, for example, devices of the wireless communications system may perform more efficient and accurate decoding of system information messages to enable communications between devices and may reduce latencies in the wireless communications system 100.

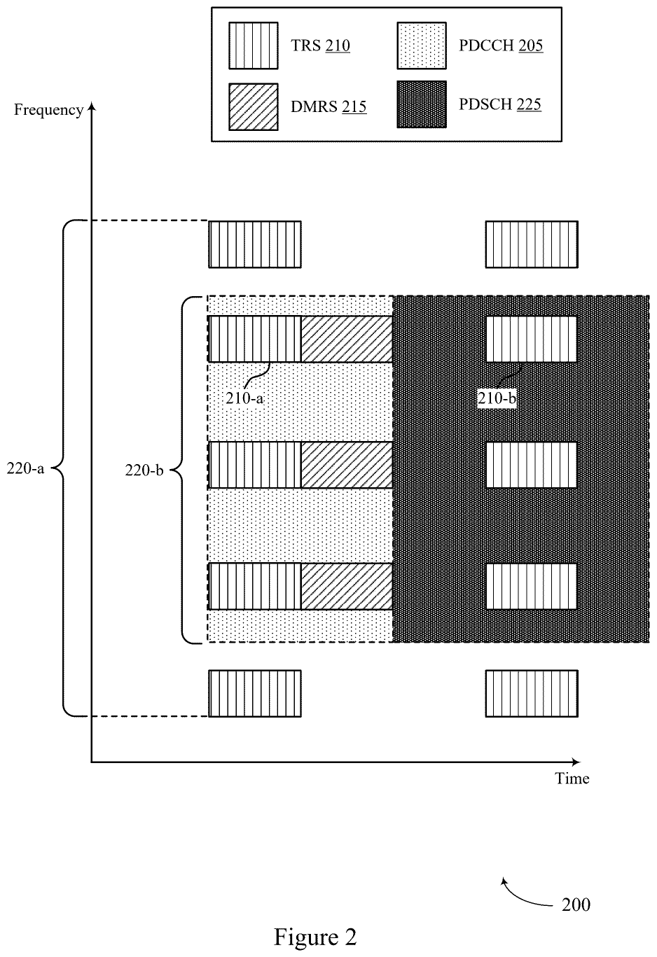

FIG. 2 shows an example of a signaling diagram 200 that supports multiplexing TRSs with system information messages. The signaling diagram 200 may implement or be implemented by aspects of the wireless communications system 100. For example, the signaling diagram 200 may illustrate one or more reference signals, such as one or more TRS 210, one or more DMRS 215, or both, which may be communicated between a network entity 105 and a UE 115 via a PDCCH 205, a PDSCH 225, or both. The PDCCH 205 may also carry DCI from the network entity 105 to the UE 115, and the DCI may schedule RMSI (e.g., SIB1) on the PDSCH 225, such that the DCI may be referred to as an RMSI DCI. In some examples, RMSI (e.g., the RMSI DCI) in the PDCCH 205 may be referred to as RMSI PDCCH and RMSI in the PDSCH 225 may be referred to as RMSI PDSCH. Additionally, or alternatively, each of the RMSI and the RMSI DCI may similarly be referred to as RMSI messages.

In accordance with examples described herein, one or more TRSs 210 and one or more RMSI messages may be multiplexed together in the PDSCH 225, in the PDCCH 205, or both. That is, the one or more TRSs 210 may be multiplexed with the RMSI in a PDSCH region (e.g., the PDSCH 225), with the RMSI DCI in a PDCCH region (e.g., the PDCCH 205), or both. In such examples, the UE 115 may leverage the one or more TRSs 210 received over a wideband to improve channel estimation for the RMSI.

A periodicity of TRSs 210 in the PDCCH 205, the PDSCH 225, or both may be aligned with a periodicity of corresponding SSB transmissions. For example, the periodicity of the TRSs 210 may be the same as a periodicity as the SSB transmissions or may be a multiple of the periodicity of the SSB transmissions. A TRS 210 associated with an SSB may be transmitted along with (e.g., multiplexed with) the RMSI corresponding to the SSB. In some examples, two SSBs may share same RMSI, and the two SSBs may also share a same TRS 210.

A bandwidth of TRSs 210 in the PDCCH 205, the PDSCH 225, or both, may be equal to or larger than a bandwidth of the RMSI or the RMSI DCI (e.g., CORESET 0, a BWP 220-b). For example, if the UE 115 is in a connected mode, the network entity 105 may transmit one or more TRSs 210 to the UE 115 over an active BWP 220-a (e.g., where the RMSI is transmitted over a default BWP 220-b). Conversely, if the UE 115 is in an idle mode (e.g., an inactive mode), the network entity 105 may transmit TRSs 210 to the UE 115 over the default BWP 220-b (e.g., where the RMSI is also transmitted over the default BWP 220-b). When the UE 115 is in the idle mode, the bandwidth of the TRSs 210 and a starting RB of the TRSs 210 may align with the default BWP 220-b.

In some examples, DMRSs 215 in the PDCCH 205 and TRSs 210 multiplexed in the PDCCH 205 may have a same density in the frequency domain (e.g., a comb-4 structure, every four tones). Accordingly, the TRSs 210 may be multiplexed with the RMSI DCI in the PDCCH 205 (e.g., PDCCH region) and may be aligned (e.g., in the frequency domain) with the DMRSs 215 in the PDCCH 205. The TRSs 210 may be distributed every 4 tones with a same tone offset as the DMRSs 215 (e.g., may completely overlap with the DMRSs 215 in frequency). In some examples, consecutive TRSs 210 may be four symbols apart. In such examples, there may be at most one TRS 210-a in the PDCCH 205, and a subsequent TRS 210-b may be outside of the PDCCH 205 (e.g., may be in a PDSCH).

The DMRSs 215 may be present with the TRSs 210 in the PDCCH 205, as depicted in FIG. 2, or the TRSs 210 may replace the DMRSs 215 (e.g., not depicted) in the PDCCH 205. In some examples, a network entity 105 may transmit the DMRSs 215 in non-TRS symbols of the PDCCH 205. In such examples, the UE 115 may perform channel estimation using a combination of the DMRSs 215 and the TRSs 210 (e.g., wideband TRSs 210). In some other examples, the TRSs 210 may replace the DMRSs 215 in the PDCCH 205. In such examples, the network entity 105 may rate match the non-TRS symbols (e.g., symbols without TRS 210) of the PDCCH 205 according to the symbols which include the TRSs 210. For example, in non-TRS symbols of a PDCCH 205 with greater than one symbol, the PDCCH 205 may be rate matched to the DMRS REs which are omitted from the PDCCH 205. In some examples, such a rate matching behavior on non-TRS symbols of the PDCCH 205 may be indicated in a master information block (MIB).

The DMRS 215 of the PDCCH 205 scheduling the RMSI or of the PDSCH 225 that carries the RMSI (e.g., SIB-1), or both may be from the random sequence with an initial seed, cᵢₙᵢₜ, according to Equation 1.

$${c}_{i n i t} = ( {2}^{17} ( {N}_{symb}^{slot} {n}_{s , f}^{μ} + l + 1 ) ( 2 {N}_{ID} + 1 ) + 2 {N}_{ID} ) mod {2}^{31} \qquad ( 1 )$$

In Equation 1 above, l may be an OFDM symbol number within a slot,

$${N}_{symb}^{slot}$$

may be a quantity of symbols per slot,

$${n}_{s , f}^{μ}$$

may be a slot number within a frame, and N_{ID} may be a cell ID. For TRS multiplexing in the PDCCH 205, the TRS 210 sequence may share a same initial seed as the overlapping DMRS 215. The initial seed of RS generation may be determined by the cell ID.

In accordance with examples described herein, the TRSs 210 may additionally, or alternatively, be multiplexed with the RMSI in the PDSCH 225 (e.g., PDSCH region). For example, the TRSs 210 may begin in the PDSCH 225 (e.g., not depicted), or a first TRS 210, such as the TRS 210-a, may be within the PDCCH 205 and a subsequent TRS 210, such as the TRS 210-b, may be within the PDSCH 225. For example, given that TRSs 210 may be four symbols apart, even if the TRS 210-a is in the PDCCH 205, the TRS 210-b may be in the PDSCH 225.

The TRSs 210 may be multiplexed in the PDSCH 225 and may be aligned (e.g., in the frequency domain) with the DMRSs 215 in the PDSCH 225. For example, tones corresponding to the TRSs 210 may overlap with tones corresponding to the DMRSs 215 according to a frequency domain resource allocation (FDRA) of the PDSCH 225. The network entity 105 may configure a first comb structure (e.g., comb-4) of the TRSs 210 to align with a second comb structure (e.g., comb-2) of the DMRSs 215. In some examples, a tone offset of the TRSs 210 in the PDSCH 225 may be the same as a tone offset of the DMRSs 215 in the PDSCH 225 (e.g., within an RB).

In some examples, the TRSs 210 may be multiplexed in the PDSCH 225 in non-DMRS symbols (e.g., symbols without DMRS). For example, the TRSs 210 may be configured to avoid DMRS symbols of the PDSCH 225. If a TRS 210 and a DMRS 215 overlap in the time domain (e.g., in overlapping symbols), the network entity 105 may move (e.g., shift) either the DMRS 215 or the TRS 210 to a different symbol. In some examples, the network entity 105 may prioritize the TRS 210 to be maintained in a configured symbol (e.g., not shifted) and may move the DMRS 215 to a different symbol (e.g., based on wideband TRSs 210 being shared between multiple UEs 115). In some cases, the network entity 105 may rate match the PDSCH 225 around tones of the TRS 210.

In some examples where the network entity 105 transmits the TRS 210-a within the PDCCH 205 and the TRS 210-b within the PDSCH 225, the TRS 210-a and the TRS 210-b may share a same frequency domain pattern. For example, the TRS 210-a in the PDCCH 205 and the TRS 210-b in the PDSCH 225 may be associated with a same tone offset, a same comb structure, or both. In such examples, the network entity 105 may configure the second comb structure of the DMRSs 215 in the PDSCH 225 to align with the first comb structure of the TRSs 210, which may be carried over from the PDCCH 205.

For TRS multiplexing in the PDSCH 225, the TRS 210 sequence may share a same initial seed as the overlapping DMRS 215. The initial seed of RS generation may be determined by a cell ID (e.g., according to Equation 1 above).

In some examples, the network entity 105 may transmit a MIB indicating one or more communication resources associated with the TRSs 210 multiplexed in the PDSCH 225, in the PDCCH 205, or both. For example, the MIB may indicate a starting CRB of the TRSs 210, a quantity of RBs of the TRSs 210, a first symbol of the RMSI (e.g., or the RMSI DCI), a tone offset of the TRSs 210, or any combination thereof. In some examples, the TRSs 210 may span the entire BWP 220-b (e.g., CORESET 0) and the starting CRB and the quantity of RBs for the TRSs 210 may be implicitly signaled (e.g., based on CORESET 0 signaling).

In some examples, the PDCCH 205 and the PDSCH 225 may carry multiple DMRS symbols. In some cases, where the TRSs 210 are multiplexed in the PDCCH 205, the MIB may indicate a first symbol for transmitting the TRSs 210 by indicating a first OFDM symbol in the time domain (e.g., FirstOFDMSymbolInTimeDomain) with respect to a search space of the RSMI DCI (e.g., RSMI PDCCH). In such cases, a first symbol of a first TRS 210 may be the indicated first OFDM symbol in the time domain, which may be within the PDCCH 205, and a second symbol of a second TRS 210 may be four symbols after the indicated first OFDM symbol in the time domain, which may fall within the PDSCH 225. In the case that the second TRS 210 is within the PDSCH 225 (e.g., as depicted in FIG. 2), the network entity 105 may shift the DMRSs 215 to align with the second TRS 210.

In some other cases, where the TRSs 210 are multiplexed in (e.g., only) the PDSCH 225, the MIB may indicate the first symbol for transmitting the TRSs 210 by indicating a first OFDM symbol in the time domain (e.g., FirstOFDMSymbolInTimeDomain) with respect to a first symbol of the RSMI PDSCH (e.g., according to a time domain resource allocation (TDRA) of the PDSCH 225). Additionally, or alternatively, the MIB may indicate which DMRS symbol in the PDSCH 2025 is the first symbol for transmitting the TRSs 210. The network entity 105 may transmit a first TRS 210 in the first symbol and may transmit a second TRS 210 four symbols later, which may be outside of the PDSCH 225.

The RMSI may include an indication of an SSB index. Accordingly, the UE may decode the RMSI to determine which PDP loop to use (e.g., to combine with) based on the indicated SSB index, such as in cases where different loops are configured for different SSB beams.

In cases where the TRSs 210 are multiplexed in the PDSCH225, the RMSI DCI (e.g., fallback DCI) may indicate the one or more communication resources associated with the TRSs 210 multiplexed in the PDSCH 225. For example, the RMSI DCI may indicate a first symbol of the TRSs 210, a tone offset of the TRSs 210, or both. In some examples, the RMSI DCI may dynamically indicate the presence of TRSs 210 in the PDSCH 225.

In some cases, the indication of the first symbol of the TRS 210 (e.g., first symbol location indication) may be with respect to a first symbol of a start and length indicator vector (SLIV) or may be with respect to the RMSI DCI (e.g., RMSI PDCCH). Additionally, or alternatively, the RMSI DCI may indicate an SSB index associated with a first TRS 210 that is transmitted via the PDSCH 225. Accordingly, the RMSI DCI may dynamically signal a presence of at least a first TRS 210 in the PDSCH 225, and a second TRS 210 following the first TRS 210 may be outside of the PDSCH 225 (e.g., based on a TDRA of the PDSCH 225).

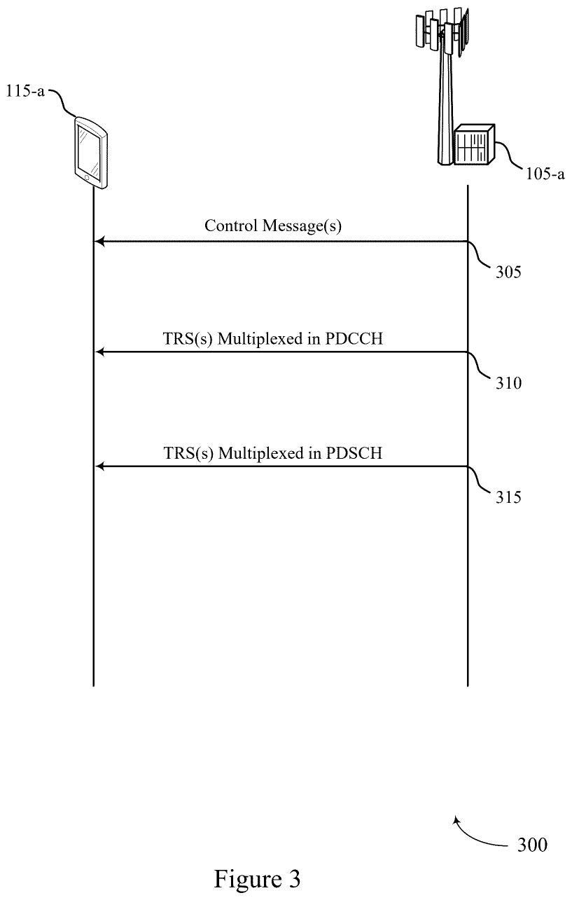

FIG. 3 shows an example of a process flow 300 that supports multiplexing TRSs with system information messages. The process flow 300 may implement or be implemented by aspects of the wireless communications system 100. For example, the process flow 300 may include a UE 115-a and a network entity 105-a, which may be examples of corresponding devices described herein. In the following description of the process flow 300, the operations may be performed in a different order than the order shown, or the operations performed by the example devices may be performed in different orders or at different times. For example, specific operations also may be left out of the process flow 300, or other operations may be added to the process flow 300. Further, although some operations or signaling may be shown to occur at different times for discussion purposes, these operations may actually occur at the same time.

At 305, the UE 115-a may receive one or more first control messages indicative of first configuration information associated with one or more TRSs and second configuration information associated with a system information message (e.g., RMSI), wherein the first configuration information is based on the second configuration information. The one or more first control message may include a MIB or a control message (e.g., RMSI DCI) scheduling the system information message. The second configuration information may configure or schedule communication of the system information messages (e.g., RMSI) via a PDSCH. The first configuration information may indicate that the one or more TRSs are multiplexed with the system information messages in the PDSCH, may indicate that the one or more TRSs are multiplexed with the control message in a PDCCH, or both.

The first configuration information may indicate one or more communication resources associated with communication of the TRSs multiplexed in the PDSCH, the PDCCH, or both. For example, the first configuration information may indicate a first RB (e.g., starting CRB) associated with the one or more TRSs, a first symbol associated with the one or more TRSs, a quantity of RBs associated with the T one or more RSs, a first symbol associated with the system information message (e.g., RMSI) or the control message (e.g., DCI) that schedules the system information message, a tone offset associated with the one or more TRSs, or any combination thereof.

At 310, the UE 115-a may receive, via the PDCCH, one or more first TRSs (e.g., of the one or more TRSs) multiplexed with the control message that schedules the RMSI. A first tone offset of the one or more first TRSs may be the same as a second tone offset of one or more first DMRSs received via the PDCCH. The one or more first TRSs may be received via a first set of time resources (e.g., TRS symbols) of the PDCCH and the one or more first DMRSs may be received via a second set of time resources (e.g., non-TRS symbols) of the PDCCH different from the first set of time resources. In some other examples, the one or more first TRSs may replace the one or more first DMRSs in the PDCCH. In such examples, the second set of time resources associated with the one or more first DMRSs are rate matched in accordance with the first set of time resources.

At 315, the UE 115-a may receive, via the PDSCH, one or more second TRSs (e.g., of the one or more TRSs) multiplexed with the system information message (e.g., RMSI). A first tone offset of the one or more second TRSs may be the same as a second tone offset of one or more second DMRSs associated with the PDSCH. The one or more second TRSs may be received on a first set of symbols (e.g., TRS symbols) of the PDSCH and the one or more second DMRSs may be received on a second set of symbols (e.g., non-TRS symbols) of the PDSCH, different from the first set of symbols.

In some examples, receiving the one or more second TRSs via the PDSCH may be in place of receiving the one or more first TRSs via the PDCCH such that the UE 115-a receives a first TRS of a TRS sequence via the PDSCH multiplexed with the system information message (e.g., RMSI). Alternatively, the UE 115-a may receive a first TRS (e.g., of the TRS sequence) via the PDCCH multiplexed with the control message (e.g., RMSI DCI) and may receive a second TRS via the PDSCH multiplexed with the RMSI. In such examples, the first TRS and the second TRS may be associated with a same tone offset, a same comb structure, or both.

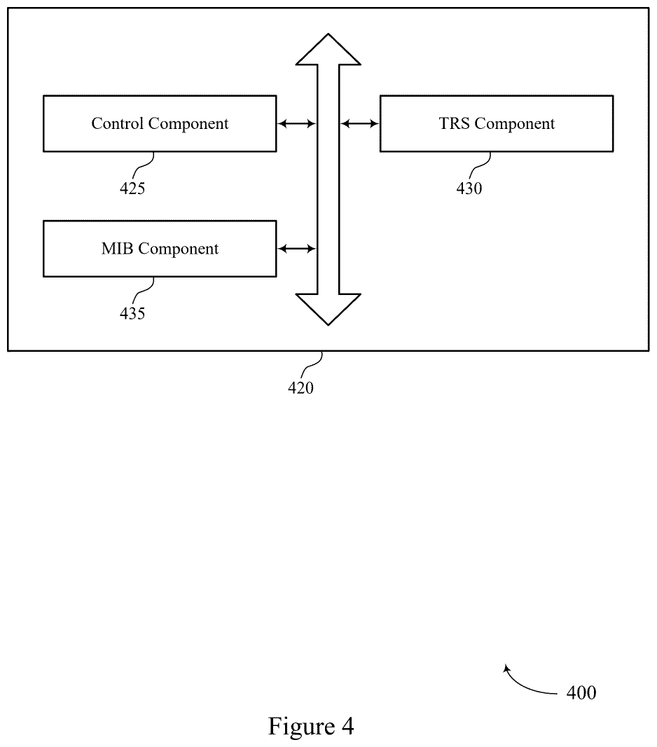

FIG. 4 shows an example of a processing system 420 that supports multiplexing TRSs with system information messages. A processing system 420 may be an example of a processing system 140 (such as of a UE 115) and may include a control component 425, an TRS component 430, a MIB component 435, or any combination thereof. A processing system 420, or various component thereof, may be an example of means for performing (such as a means for causing a UE 115 to perform) various techniques described herein.

The control component 425 may be configured to cause the UE 115 to receive one or more first control messages indicative of first configuration information associated with one or more TRSs and second configuration information associated with a system information message, where the first configuration information is based on the second configuration information. The TRS component 430 may be configured to cause the UE 115 to receive, in accordance with the first configuration information, the one or more TRSs, where the one or more TRSs are multiplexed with the system information message, a second control message that schedules the system information message, or both.

In some examples, receipt of the one or more TRSs is via a PDSCH associated with the system information message. In some examples, the one or more TRSs are multiplexed with the system information message on the PDSCH.

In some examples, a first tone offset of the one or more TRSs is the same as a second tone offset of one or more DMRSs associated with the PDSCH.

In some examples, the one or more TRSs are received on a first set of symbols of the PDSCH. In some examples, one or more DMRSs are received on a second set of symbols of the PDSCH, different from the first set of symbols.

In some examples, the one or more TRSs are one or more first TRSs, and the TRS component 430 may be configured to cause the UE 115 to receive, before receiving the one or more first TRSs via the PDSCH associated with the system information message, one or more second TRSs via a PDCCH associated with the system information message, where the one or more first TRSs and the one or more second TRSs are associated with a same tone offset, a same comb structure, or both.

In some examples, receipt of the one or more TRSs is via a PDCCH associated with the second control message that schedules the system information message. In some examples, the one or more TRSs are multiplexed with the second control message on the PDCCH.

In some examples, a first tone offset of the one or more TRSs is the same as a second tone offset of one or more DMRSs associated with the PDCCH.

In some examples, the one or more TRSs are received via a first set of time resources of the PDCCH. In some examples, one or more DMRSs are received via a second set of time resources of the PDCCH, different from the first set of time resources.

In some examples, the one or more TRSs replace one or more DMRSs. In some examples, the one or more TRSs are received via a first set of time resources of the PDCCH. In some examples, a second set of time resources associated with the one or more DMRSs, different from the first set of time resources, are rate matched in accordance with the first set of time resources.

In some examples, a first sequence of the one or more TRSs is associated with a first seed value. In some examples, the first seed value is the same as a second seed value associated with a second sequence of one or more DMRSs associated with the system information message.

In some examples, to support receiving the one or more first control messages, the MIB component 435 may be configured to cause the UE 115 to receive a MIB indicative of the first configuration information, where the first configuration information indicates a first RB associated with the one or more TRSs, a first symbol associated with the one or more TRSs, a quantity of RBs associated with the one or more TRSs, a first symbol associated with the system information message, a tone offset associated with the one or more TRSs, or any combination thereof.

In some examples, the first symbol associated with the one or more TRSs is relative to a search space associated with the second control message scheduling the system information message or is relative to the first symbol associated with the system information message. In some examples, the second configuration information indicates the search space, the first symbol associated with the system information message, or both.

In some examples, to support receiving the one or more first control messages, the control component 425 may be configured to cause the UE 115 to receive, via a PDCCH, the second control message indicative of the first configuration information, where the first configuration information includes a first symbol associated with the one or more TRSs, a tone offset associated with the one or more TRSs, or both, and where the one or more TRSs are multiplexed with the system information message on a PDSCH based on the second control message that schedules the system information message being indicative of the first configuration information.

In some examples, the first symbol associated with the one or more TRSs is relative to a first symbol associated with the system information message. In some examples, the second configuration information indicates the first symbol associated with the system information message.

In some examples, the second control message further indicates a presence of the one or more TRSs on the PDSCH, a synchronization signal block index associated with the one or more TRSs, or both.

In some examples, the UE is in an idle mode or an inactive mode. In some examples, a first bandwidth associated with the one or more TRSs is the same as a second bandwidth associated with the system information message based on the UE being in the idle mode or the inactive mode.

In some examples, the UE is in a connected mode. In some examples, a first bandwidth associated with the one or more TRSs is greater than or equal to a second bandwidth associated with the system information message based on the UE being in the connected mode.

In some examples, a first periodicity of the one or more TRSs is the same as a second periodicity of one or more synchronization signal blocks associated with the one or more TRSs.

In some examples, the one or more TRSs are associated with one or more synchronization signal blocks. In some examples, the one or more TRSs being multiplexed with the system information message, the second control message that schedules the system information message, or both, is based on the system information message corresponding to the one or more synchronization signal blocks.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reduced processing, reduced power consumption, and more efficient utilization of communication resources.

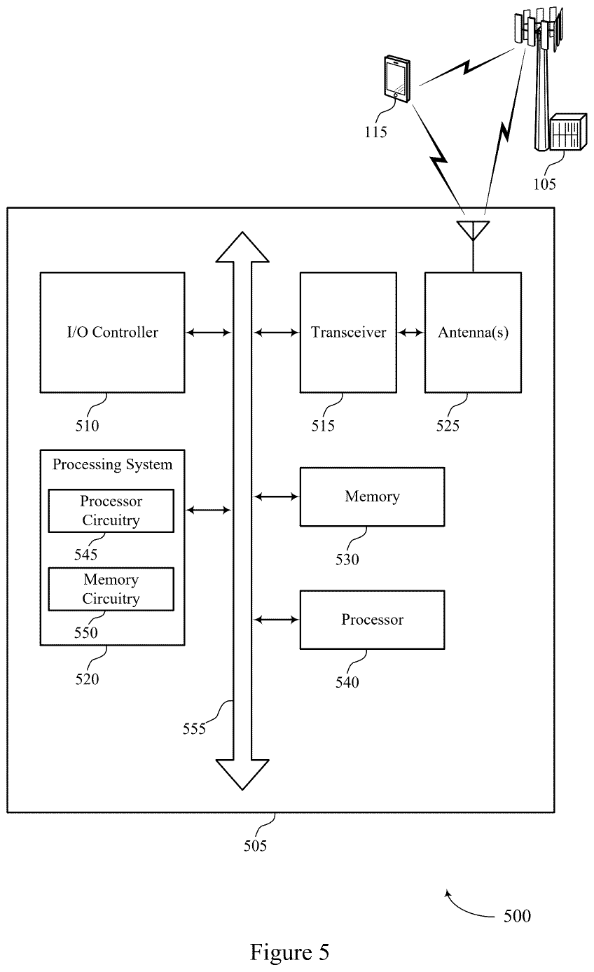

FIG. 5 shows an example of a system 500 including a device 505 that supports multiplexing TRSs with system information messages. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support multiplexing TRSs with system information messages. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, reduced latency, improved user experience related to reduced processing, reduced power consumption, more efficient utilization of communication resources, and longer battery life.

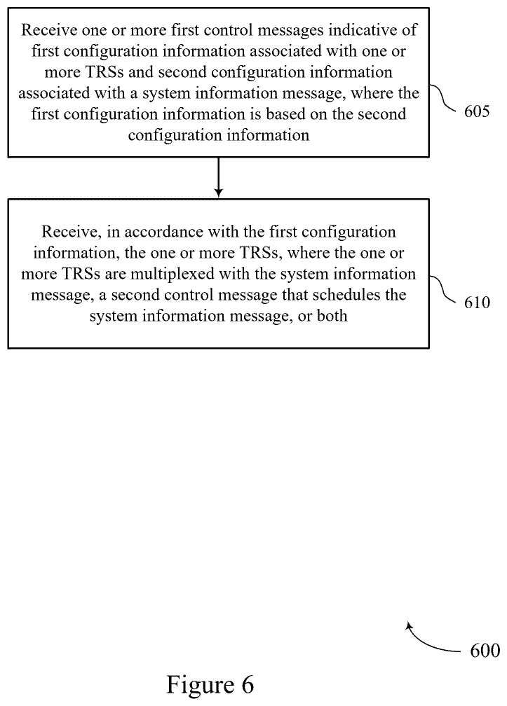

FIG. 6 shows an example of a method 600 that supports multiplexing TRSs with system information messages. Operations of the method 600 may be performed by a UE or its components (such as using a processing system configured to cause the UE 115 to perform one or more of the operations) as described herein.

At 605, the method may include receiving one or more first control messages indicative of first configuration information associated with one or more TRSs and second configuration information associated with a system information message, wherein the first configuration information is based at least in part on the second configuration information. In some examples, aspects of the operations of 605 may be performed by a control component 425.

At 610, the method may include receiving, in accordance with the first configuration information, the one or more TRSs, wherein the one or more TRSs are multiplexed with the system information message, a second control message that schedules the system information message, or both. In some examples, aspects of the operations of 610 may be performed by an TRS component 430.

Implementation examples are described in the following numbered clauses:

Aspect 1: A method for wireless communications by a UE, including: receiving one or more first control messages indicative of first configuration information associated with one or more TRSs and second configuration information associated with a system information message, where the first configuration information is based on the second configuration information; and receiving, in accordance with the first configuration information, the one or more TRSs, where the one or more TRSs are multiplexed with the system information message, a second control message that schedules the system information message, or both.

Aspect 2: The method of aspect 1, where receipt of the one or more TRSs is via a PDSCH associated with the system information message, and the one or more TRSs are multiplexed with the system information message on the PDSCH.

Aspect 3: The method of aspect 2, where a first tone offset of the one or more TRSs is the same as a second tone offset of one or more DMRSs associated with the PDSCH.

Aspect 4: The method of any of aspects 2 through 3, where the one or more TRSs are received on a first set of symbols of the PDSCH, and one or more DMRSs are received on a second set of symbols of the PDSCH, different from the first set of symbols.

Aspect 5: The method of any of aspects 2 through 4, where the one or more TRSs are one or more first TRSs, the method further including: receiving, before receiving the one or more first TRSs via the PDSCH associated with the system information message, one or more second TRSs via a PDCCH associated with the system information message, where the one or more first TRSs and the one or more second TRSs are associated with a same tone offset, a same comb structure, or both.

Aspect 6: The method of any of aspects 1 through 5, where receipt of the one or more TRSs is via a PDCCH associated with the second control message that schedules the system information message, the one or more TRSs are multiplexed with the second control message on the PDCCH.

Aspect 7: The method of aspect 6, where a first tone offset of the one or more TRSs is the same as a second tone offset of one or more DMRSs associated with the PDCCH.

Aspect 8: The method of any of aspects 6 through 7, where the one or more TRSs are received via a first set of time resources of the PDCCH, and one or more DMRSs are received via a second set of time resources of the PDCCH, different from the first set of time resources.

Aspect 9: The method of any of aspects 6 through 8, where the one or more TRSs replace one or more DMRSs, the one or more TRSs are received via a first set of time resources of the PDCCH, and a second set of time resources associated with the one or more DMRSs, different from the first set of time resources, are rate matched in accordance with the first set of time resources.

Aspect 10: The method of any of aspects 1 through 9, where a first sequence of the one or more TRSs is associated with a first seed value, and the first seed value is the same as a second seed value associated with a second sequence of one or more DMRSs associated with the system information message.

Aspect 11: The method of any of aspects 1 through 10, where receiving the one or more first control messages includes: receiving a MIB indicative of the first configuration information, where the first configuration information indicates a first RB associated with the one or more TRSs, a first symbol associated with the one or more TRSs, a quantity of RBs associated with the one or more TRSs, a first symbol associated with the system information message, a tone offset associated with the one or more TRSs, or any combination thereof.

Aspect 12: The method of aspect 11, where the first symbol associated with the one or more TRSs is relative to a search space associated with the second control message scheduling the system information message or is relative to the first symbol associated with the system information message, and the second configuration information indicates the search space, the first symbol associated with the system information message, or both.

Aspect 13: The method of any of aspects 1 through 12, where the one or more first control messages include the second control message that schedules the system information message, and where receiving the one or more first control messages includes: receiving, via a PDCCH, the second control message indicative of the first configuration information, where the first configuration information includes a first symbol associated with the one or more TRSs, a tone offset associated with the one or more TRSs, or both, and where the one or more TRSs are multiplexed with the system information message on a PDSCH based on the second control message that schedules the system information message being indicative of the first configuration information.

Aspect 14: The method of aspect 13, where the first symbol associated with the one or more TRSs is relative to a first symbol associated with the system information message, and the second configuration information indicates the first symbol associated with the system information message.

Aspect 15: The method of any of aspects 13 through 14, where the second control message further indicates a presence of the one or more TRSs on the PDSCH, a synchronization signal block index associated with the one or more TRSs, or both.

Aspect 16: The method of any of aspects 1 through 15, where the UE is in an idle mode or an inactive mode, and a first bandwidth associated with the one or more TRSs is the same as a second bandwidth associated with the system information message based on the UE being in the idle mode or the inactive mode.

Aspect 17: The method of any of aspects 1 through 16, where the UE is in a connected mode, and a first bandwidth associated with the one or more TRSs is greater than or equal to a second bandwidth associated with the system information message based on the UE being in the connected mode.

Aspect 18: The method of any of aspects 1 through 17, where a first periodicity of the one or more TRSs is the same as a second periodicity of one or more synchronization signal blocks associated with the one or more TRSs.

Aspect 19: The method of any of aspects 1 through 18, where the one or more TRSs are associated with one or more synchronization signal blocks, and the one or more TRSs being multiplexed with the system information message, the second control message that schedules the system information message, or both, is based on the system information message corresponding to the one or more synchronization signal blocks.

Aspect 20: A UE, including: one or more memories storing processor-executable code; and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to: receive one or more first control messages indicative of first configuration information associated with one or more TRSs and second configuration information associated with a system information message, where the first configuration information is based on the second configuration information; and receive, in accordance with the first configuration information, the one or more TRSs, where the one or more TRSs are multiplexed with the system information message, a second control message that schedules the system information message, or both.

Aspect 21: The UE of aspect 20, where receipt of the one or more TRSs is via a PDSCH associated with the system information message, and the one or more TRSs are multiplexed with the system information message on the PDSCH.

Aspect 22: The UE of aspect 21, where a first tone offset of the one or more TRSs is the same as a second tone offset of one or more DMRSs associated with the PDSCH.

Aspect 23: The UE of any of aspects 21 through 22, where the one or more TRSs are received on a first set of symbols of the PDSCH, and one or more DMRSs are received on a second set of symbols of the PDSCH, different from the first set of symbols.

Aspect 24: The UE of any of aspects 21 through 23, where the one or more TRSs are one or more first TRSs, and the one or more processors are individually or collectively further operable to execute the code to cause the UE to: receive, before receiving the one or more first TRSs via the PDSCH associated with the system information message, one or more second TRSs via a PDCCH associated with the system information message, where the one or more first TRSs and the one or more second TRSs are associated with a same tone offset, a same comb structure, or both.

Aspect 25: The UE of any of aspects 20 through 24, where receipt of the one or more TRSs is via a PDCCH associated with the second control message that schedules the system information message, the one or more TRSs are multiplexed with the second control message on the PDCCH.

Aspect 26: The UE of aspect 25, where a first tone offset of the one or more TRSs is the same as a second tone offset of one or more DMRSs associated with the PDCCH.

Aspect 27: The UE of any of aspects 25 through 26, where the one or more TRSs are received via a first set of time resources of the PDCCH, and one or more DMRSs are received via a second set of time resources of the PDCCH, different from the first set of time resources.

Aspect 28: The UE of any of aspects 25 through 27, where: the one or more TRSs replace one or more DMRSs, the one or more TRSs are received via a first set of time resources of the PDCCH, and a second set of time resources associated with the one or more DMRSs, different from the first set of time resources, are rate matched in accordance with the first set of time resources.

Aspect 29: The UE of any of aspects 20 through 28, where a first sequence of the one or more TRSs is associated with a first seed value, and the first seed value is the same as a second seed value associated with a second sequence of one or more DMRSs associated with the system information message.

Aspect 30: The UE of any of aspects 20 through 29, where, to receive the one or more first control messages, the one or more processors are individually or collectively operable to execute the code to cause the UE to: receive a MIB indicative of the first configuration information, where the first configuration information indicates a first RB associated with the one or more TRSs, a first symbol associated with the one or more TRSs, a quantity of RBs associated with the one or more TRSs, a first symbol associated with the system information message, a tone offset associated with the one or more TRSs, or any combination thereof.

Aspect 31: The UE of aspect 30, where the first symbol associated with the one or more TRSs is relative to a search space associated with the second control message scheduling the system information message or is relative to the first symbol associated with the system information message, and the second configuration information indicates the search space, the first symbol associated with the system information message, or both.

Aspect 32: The UE of any of aspects 20 through 31, where, to receive the one or more first control messages, the one or more processors are individually or collectively operable to execute the code to cause the UE to: receive, via a PDCCH, the second control message indicative of the first configuration information, where the first configuration information includes a first symbol associated with the one or more TRSs, a tone offset associated with the one or more TRSs, or both, and where the one or more TRSs are multiplexed with the system information message on a PDSCH based on the second control message that schedules the system information message being indicative of the first configuration information.

Aspect 33: The UE of aspect 32, where the first symbol associated with the one or more TRSs is relative to a first symbol associated with the system information message, and the second configuration information indicates the first symbol associated with the system information message.

Aspect 34: The UE of any of aspects 32 through 33, where the second control message further indicates a presence of the one or more TRSs on the PDSCH, a synchronization signal block index associated with the one or more TRSs, or both.

Aspect 35: The UE of any of aspects 20 through 34, where the UE is in an idle mode or an inactive mode, and a first bandwidth associated with the one or more TRSs is the same as a second bandwidth associated with the system information message based on the UE being in the idle mode or the inactive mode.

Aspect 36: The UE of any of aspects 20 through 35, where the UE is in a connected mode, and a first bandwidth associated with the one or more TRSs is greater than or equal to a second bandwidth associated with the system information message based on the UE being in the connected mode.

Aspect 37: The UE of any of aspects 20 through 36, where a first periodicity of the one or more TRSs is the same as a second periodicity of one or more synchronization signal blocks associated with the one or more TRSs.

Aspect 38: The UE of any of aspects 20 through 37, where: the one or more TRSs are associated with one or more synchronization signal blocks, and the one or more TRSs being multiplexed with the system information message, the second control message that schedules the system information message, or both, is based on the system information message corresponding to the one or more synchronization signal blocks.

Aspect 39: A non-transitory computer-readable medium storing code for wireless communications, the code including instructions executable by one or more processors (e.g., directly, indirectly, after pre-processing, without pre-processing) to: receive one or more first control messages indicative of first configuration information associated with one or more TRSs and second configuration information associated with a system information message, where the first configuration information is based on the second configuration information; and receive, in accordance with the first configuration information, the one or more TRSs, where the one or more TRSs are multiplexed with the system information message, a second control message that schedules the system information message, or both.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies, including future systems and radio technologies, not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, e.g., when executing code (such as processor-executable code) stored in memory circuitry or otherwise, to perform one or more of the functions described herein.

As used herein, the term “determine” or “determining” or “identify” or “identifying” can encompass one or more of a variety of actions. For example, “determining” or “identifying” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining or identifying can involve a processing system performing some type of calculating, computing, deriving, estimating, inferring, ascertaining, resolving, predicting, or other processing to obtain one or more numerical values, sets, elements, or other information or results. In some such examples, determining or identifying can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining or identifying can involve a processing system identifying, interpreting, demodulating, decoding, detecting, reading, or otherwise obtaining some type of value, set, element, or other information or result signaled in, for example, a received wireless signal. In some such examples, determining or identifying can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more first control messages indicative of first configuration information associated with one or more tracking reference signals and second configuration information associated with a system information message, wherein the first configuration information is based at least in part on the second configuration information; and
receive, in accordance with the first configuration information, the one or more tracking reference signals, wherein the one or more tracking reference signals are multiplexed with the system information message, a second control message that schedules the system information message, or both.

2. The UE of claim 1, wherein receipt of the one or more tracking reference signals is via a physical downlink shared channel associated with the system information message, and wherein the one or more tracking reference signals are multiplexed with the system information message on the physical downlink shared channel.

3. The UE of claim 2, wherein a first tone offset of the one or more tracking reference signals is the same as a second tone offset of one or more demodulation reference signals associated with the physical downlink shared channel.

4. The UE of claim 2, wherein the one or more tracking reference signals are received on a first set of symbols of the physical downlink shared channel, and wherein one or more demodulation reference signals are received on a second set of symbols of the physical downlink shared channel, different from the first set of symbols.

5. The UE of claim 2, wherein the one or more tracking reference signals are one or more first tracking reference signals, and the one or more processors are individually or collectively further operable to execute the code to cause the UE to:
receive, before receiving the one or more first tracking reference signals via the physical downlink shared channel associated with the system information message, one or more second tracking reference signals via a physical downlink control channel associated with the system information message, wherein the one or more first tracking reference signals and the one or more second tracking reference signals are associated with a same tone offset, a same comb structure, or both.

6. The UE of claim 1, wherein receipt of the one or more tracking reference signals is via a physical downlink control channel associated with the second control message that schedules the system information message, and wherein the one or more tracking reference signals are multiplexed with the second control message on the physical downlink control channel.

7. The UE of claim 6, wherein a first tone offset of the one or more tracking reference signals is the same as a second tone offset of one or more demodulation reference signals associated with the physical downlink control channel.

8. The UE of claim 6, wherein the one or more tracking reference signals are received via a first set of time resources of the physical downlink control channel, and wherein one or more demodulation reference signals are received via a second set of time resources of the physical downlink control channel, different from the first set of time resources.

9. The UE of claim 6, wherein the one or more tracking reference signals replace one or more demodulation reference signals, wherein the one or more tracking reference signals are received via a first set of time resources of the physical downlink control channel, and wherein a second set of time resources associated with the one or more demodulation reference signals, different from the first set of time resources, are rate matched in accordance with the first set of time resources.

10. The UE of claim 1, wherein a first sequence of the one or more tracking reference signals is associated with a first seed value, and wherein the first seed value is the same as a second seed value associated with a second sequence of one or more demodulation reference signals associated with the system information message.

11. The UE of claim 1, wherein, to receive the one or more first control messages, the one or more processors are individually or collectively operable to execute the code to cause the UE to:
receive a master information block indicative of the first configuration information, wherein the first configuration information indicates a first resource block associated with the one or more tracking reference signals, a first symbol associated with the one or more tracking reference signals, a quantity of resource blocks associated with the one or more tracking reference signals, a first symbol associated with the system information message, a tone offset associated with the one or more tracking reference signals, or any combination thereof.

12. The UE of claim 11, wherein the first symbol associated with the one or more tracking reference signals is relative to a search space associated with the second control message scheduling the system information message or is relative to the first symbol associated with the system information message, and wherein the second configuration information indicates the search space, the first symbol associated with the system information message, or both.

13. The UE of claim 1, wherein, to receive the one or more first control messages, the one or more processors are individually or collectively operable to execute the code to cause the UE to:
receive, via a physical downlink control channel, the second control message indicative of the first configuration information, wherein the first configuration information comprises a first symbol associated with the one or more tracking reference signals, a tone offset associated with the one or more tracking reference signals, or both, and wherein the one or more tracking reference signals are multiplexed with the system information message on a physical downlink shared channel based at least in part on the second control message that schedules the system information message being indicative of the first configuration information.

14. The UE of claim 13, wherein the first symbol associated with the one or more tracking reference signals is relative to a first symbol associated with the system information message, and wherein the second configuration information indicates the first symbol associated with the system information message.

15. The UE of claim 13, wherein the second control message further indicates a presence of the one or more tracking reference signals on the physical downlink shared channel, a synchronization signal block index associated with the one or more tracking reference signals, or both.

16. The UE of claim 1, wherein the UE is in an idle mode or an inactive mode, and wherein a first bandwidth associated with the one or more tracking reference signals is the same as a second bandwidth associated with the system information message based at least in part on the UE being in the idle mode or the inactive mode.

17. The UE of claim 1, wherein the UE is in a connected mode, and wherein a first bandwidth associated with the one or more tracking reference signals is greater than or equal to a second bandwidth associated with the system information message based at least in part on the UE being in the connected mode.

18. The UE of claim 1, wherein the one or more tracking reference signals are associated with one or more synchronization signal blocks, and wherein the one or more tracking reference signals being multiplexed with the system information message, the second control message that schedules the system information message, or both, is based at least in part on the system information message corresponding to the one or more synchronization signal blocks.

19. A method for wireless communications by a user equipment (UE), comprising:
receiving one or more first control messages indicative of first configuration information associated with one or more tracking reference signals and second configuration information associated with a system information message, wherein the first configuration information is based at least in part on the second configuration information; and
receiving, in accordance with the first configuration information, the one or more tracking reference signals, wherein the one or more tracking reference signals are multiplexed with the system information message, a second control message that schedules the system information message, or both.

20. A non-transitory computer-readable medium storing code for wireless communications, the code comprising instructions executable by one or more processors to:
receive one or more first control messages indicative of first configuration information associated with one or more tracking reference signals and second configuration information associated with a system information message, wherein the first configuration information is based at least in part on the second configuration information; and
receive, in accordance with the first configuration information, the one or more tracking reference signals, wherein the one or more tracking reference signals are multiplexed with the system information message, a second control message that schedules the system information message, or both.
